(19) United States
(12) Patent Application Publication
(10) Pub. No.: US 2026/0336555 A1
(43) Pub. Date: Oct. 29, 2026

(54) VEHICLE BRACKET AND VEHICLE

(71) Applicant: KAWASAKI MOTORS, LTD., Hyogo (JP)

(72) Inventor: Alexander RICKABAUGH, Lincoln, NE (US)

(73) Assignee: KAWASAKI MOTORS, LTD., Hyogo (JP)

(21) Appl. No.: 19/652,695

(22) Filed: Apr. 20, 2026

Related U.S. Application Data
(60) Provisional application No. 63/793,473, filed on Apr. 23, 2025.

(51) Int. Cl. B60R 21/13; B62D 27/02

(52) U.S. Cl. CPC B60R 21/13; B62D 27/023

(57) ABSTRACT

A vehicle bracket is attached to an attachment target portion of a vehicle body in an intermediate portion of the vehicle body in a vehicle width direction. The vehicle bracket includes: a base to which a support target component is attached; a first leg portion protruding from the base and fixed to the attachment target portion; and a second leg portion protruding from the base at a position away from the first leg portion and fixed to the attachment target portion. The first leg portion is longer than the second leg portion.

### CROSS-REFERENCE TO RELATED APPLICATION

The present application claims priority to U.S. Provisional Application No. 63/793,473 filed on Apr. 23, 2025, the content of which is incorporated herein by reference.

### TECHNICAL FIELD

The present disclosure relates to a technique for supporting a support target component such as an accessory by a vehicle body.

### BACKGROUND ART

U.S. Pat. No. 7,717,394 B2 discloses a vehicle interior accessory retainer including a base, a plate spring, a base inner, and a mirror assembly. A pivot of a stay in a mirror assembly is pressed into a socket formed in the base inner. Accordingly, mirror assembly is assembled to the base inner.

### SUMMARY

A vehicle bracket is a vehicle bracket attached to an attachment target portion of a vehicle body in an intermediate portion of the vehicle body in a vehicle width direction, including: a base to which a support target component is attached; a first leg portion protruding from the base and fixed to the attachment target portion; and a second leg portion protruding from the base at a position away from the first leg portion and fixed to the attachment target portion, wherein the first leg portion is longer than the second leg portion.

A vehicle is a vehicle including: a vehicle body including a vehicle body frame including a rollover protective structure; a seat including a seating part and a backrest part; and a vehicle bracket, wherein the rollover protective structure has a rod-like member located more frontward than the backrest part and extending along a vehicle width direction, the vehicle bracket includes: a base to which a support target component is attached; a first leg portion protruding from the base and fixed to the rod-like member; and a second leg portion protruding from the base at a position away from the first leg portion and fixed to the rod-like member, and the first leg portion is longer than the second leg portion.

Another vehicle bracket is a vehicle bracket attached to an attachment target portion of a vehicle body in an intermediate portion of the vehicle body in a vehicle width direction, including: a base including an attachment surface to which a support target component is attached; and a leg portion protruding from the base and fixed to the attachment target portion, wherein the leg portion is fixed to the attachment target portion in a state where the attachment surface is inclined with respect to a vehicle width direction.

The objects, features, aspects, and advantages of this disclosure will become more apparent from the following detailed description and the accompanying diagrams.

### BRIEF DESCRIPTION OF DRAWINGS

FIG. 1 is a side view illustrating a vehicle according to an embodiment.

FIG. 2 is a plan view illustrating a front portion of the vehicle.

FIG. 3 is a plan view illustrating a bracket attached to a lateral frame.

FIG. 4 is a perspective view illustrating a vehicle bracket.

FIG. 5 is a bottom view illustrating the bracket.

FIG. 6 is a development view illustrating the bracket.

FIG. 7 is a back view illustrating the bracket attached to the lateral frame.

FIG. 8 is a cross-sectional view at a VIII-VIII line in FIG. 7.

### DESCRIPTION OF THE PREFERRED EMBODIMENTS

A vehicle bracket and a vehicle according to an embodiment will be hereinafter described.

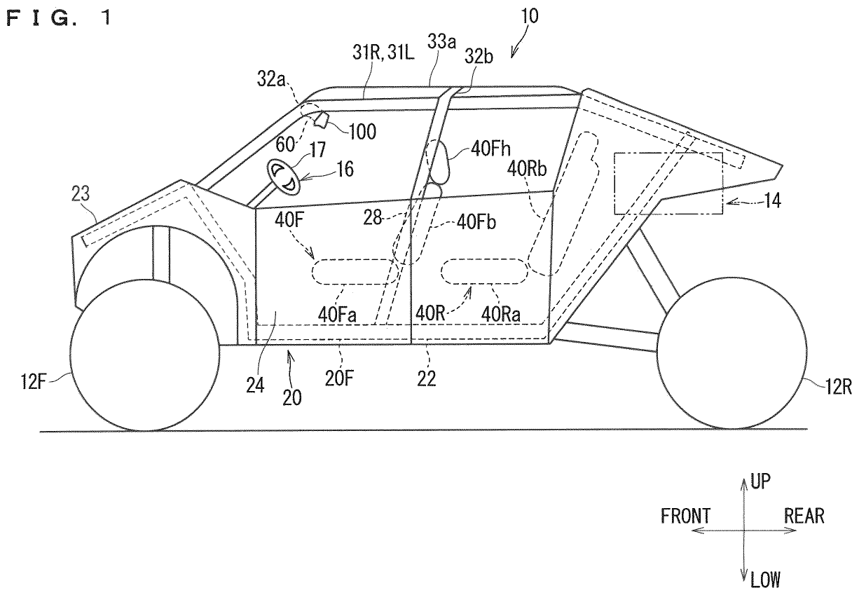

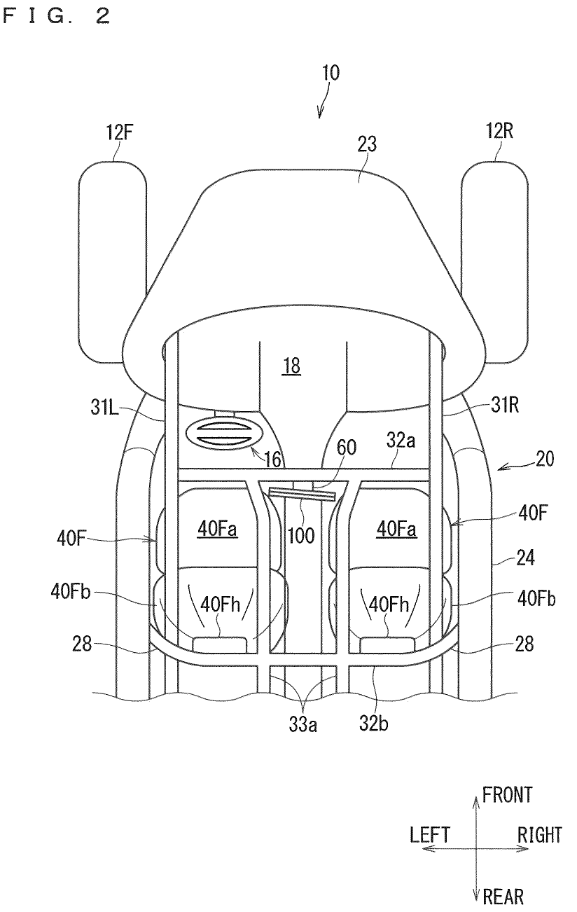

A whole structure of a vehicle including the vehicle bracket is described. FIG. 1 is a side view illustrating a vehicle 10. FIG. 2 is a plan view illustrating a front portion of the vehicle 10. In the description hereinafter, a travel direction of the vehicle 10 may be expressed as FRONT, a direction opposite to the travel direction may be expressed as REAR, a road surface side on which the vehicle 10 travels may be expressed as LOW, and a side opposite to the road surface side may be expressed as UP. The RIGHT-LEFT may be referred to while a person faces forward in the vehicle 10. A right-left direction is a vehicle width direction.

The vehicle 10 is a wheeled vehicle traveling on the road surface. The vehicle 10 may be an off-road vehicle, for example. The off-road vehicle may be a versatile small vehicle suitable for off-road travel rather than for fast travel on a public road. The off-road vehicle may be a vehicle including wheels suitable for travel on an uneven terrain. The wheels suitable for travel on the uneven terrain may be low-pressure tires; in other words, balloon tires, for example. The low-pressure tire is a tire that is designed to be filled with air with an upper limit value of 40 kPa or less, for example. When the low-pressure tire is used, deformation of the tire is allowed in accordance with unevenness of a road surface, and a ground contact area between the wheels and a ground contact surface can be increased. The wheel may be a wheel which is not filled with air but applies an elastically-deformed spoke.

Examples of the off-road vehicle include a side-by-side vehicle. The side-by-side vehicle is, for example, a small vehicle suitable for all terrain travel, and a vehicle in which passengers can be seated side by side. The side-by-side vehicle may be, for example, a multipurpose off-highway utility vehicle (MOHUV) defined by ANSI/OPEI B71.9-2016, and a recreational off-highway vehicle defined by ANSI/ROHVA 1-2016.

The vehicle 10 may be a passenger transport vehicle designed to travel at low speeds within a limited area.

Examples of the limited area may include limited community areas, private roads, and private lands (e.g., golf courses, parks, etc.). The limited community areas are areas provided for use by community residents. The community areas are, for example, areas including houses and public facilities (e.g., schools, hospitals, etc.), and are areas in which the vehicle designed to travel through non-public highways are permitted to travel at low speeds. The low speed is, for example, a speed with an upper limit ranging from 20 mph to 30 mph. The vehicle 10 includes a personal transport vehicle (PTV) in accordance with ANSI/ILTVA Z135 and a golf cart in accordance with ANSI/ILTVA Z130.1. The vehicle 10 includes a personal transportation electric vehicle.

The vehicle 10 includes a vehicle body 20, seats 40F and 40R, and a vehicle bracket 60. The vehicle 10 may further include wheels 12F and 12R, a travel drive apparatus 14, and a steering apparatus 16.

The vehicle body 20 is a support structure part supporting each constituent part of the vehicle 10. The vehicle body 20 includes a vehicle body frame 20F. The vehicle body frame 20F is structured by combining, for example, metallic pipe components, sheet metal components, or cast components.

The vehicle body frame 20F includes a floor frame 22 and a rollover protective structure (ROPS) 30.

The floor frame 22 is a frame spreading on a lower side in the vehicle 10. The ROPS 30 is a frame spreading on an upper side in the vehicle 10. The floor frame 22 and the ROPS 30 may be connected by a pillar frame 28.

For example, the floor frame 22 includes a passenger lower part spreading below a passenger space and a front part and a back part protruding above the passenger lower part in front and back of the passenger lower part, respectively.

A floor part of the vehicle body 20 may have a monocoque structure.

The wheels 12F and 12R are rotatably supported on the floor frame 22. The wheels 12F and 12R may be supported on the floor frame 22 via a suspension apparatus. The wheels 12F and 12R may include two front wheels 12F and two rear wheels 12R. For example, two front wheels 12F are rotatably supported on right and left portions in a front part of the floor frame. One front wheel is also applicable. For example, two rear wheels 12R are rotatably supported on right and left portions in a rear part of the floor frame 22.

The travel drive apparatus 14 is an apparatus for making the vehicle 10 travel. The travel drive apparatus 14 is supported on the vehicle body frame 20F. The travel drive apparatus 14 includes a motor, for example. The motor may be an internal combustion engine or an electrical motor. For example, a rotation shaft of the motor is connected to a shaft of the rear wheel 12R directly or via a gear. When rotation drive force of the motor is transmitted to the wheel 12R, the vehicle 10 can travel. The rotation drive force of the motor may be transmitted to the front and rear wheels 12R and 12F or only the front wheel 12F.

The steering apparatus 16 is an apparatus for controlling a travel operation of the vehicle 10. The travel operation is traveling, stopping, a speed, and a travel direction of the vehicle 10, for example.

The steering apparatus 16 includes a steering wheel located more backward than the front wheel 12F, for example. The steering wheel 17 is rotatably supported by a steering shaft. The steering wheel 17 is located closer to a front side above the floor frame 22. The steering wheel 17 is located more frontward than the first seat 40F. The steering shaft is connected to the front wheel 12F via a steering gear, for example. The front wheel 12F is rotated around a steering shaft by an operation of the steering wheel 17. The travel direction of the vehicle 10 is changed by rotation of the front wheel 12F around the steering shaft.

The steering wheel 17 may be disposed closer to a left side or a right side in the vehicle width direction. A state where the steering wheel 17 is disposed closer to the left side in the vehicle width direction indicates that a rotation axis of the steering wheel 17 is located closer to the left side in relation to a center line in the vehicle 10 in the vehicle width direction. A state where the steering wheel 17 is disposed closer to the right side in the vehicle width direction indicates that the rotation axis of the steering wheel 17 is located closer to the right side in relation to the center line in the vehicle 10 in the vehicle width direction. Described in the present embodiment is an example that the steering wheel 17 is located closer to the left side in the vehicle width direction.

An installment panel 18 displaying a speed meter a battery remaining amount, etc., for example, may be disposed more frontward than the steering wheel 17. An operation pedal may be disposed in a position below the steering wheel 17. The operation pedal may be one pedal capable of controlling start, acceleration, deceleration, and stop by adjusting a degree of pressing the pedal, for example. The operation pedal may be a brake pedal and an acceleration pedal.

The seats 40F and 40R are supported on the passenger lower part of the floor frame 22. The floor panel may be supported on the floor frame 22. The seats 40F and 40R may be supported on the floor frame 22 via the floor panel.

The seats 40F and 40R may include the first seat 40F and the second seat 40R. The first seat 40F is located above the floor panel and more backward than the installment panel 18. The first seat 40F is located more frontward than the second seat 40R. The first seat 40F includes the driver seat. The driver seat is located in back of the steering wheel 17. In the present embodiment, both the steering wheel 17 and the driver seat are located closer to the left side. A driver can be seated on the driver seat to operate the steering wheel 17 and the operation pedal.

The first seat 40F may include a seat on which the other passenger can be seated adjacent to the driver. The first seat 40F may have a width large enough for two passengers including the driver to be seated side by side on right and left sides. In the present embodiment, the first seat 40F includes a driver seat and a passenger seat located adjacent to the driver seat.

The first seat 40F includes a seating part 40Fa and a backrest part 40Fb, for example. A back of the passenger seated on the seating part 40Fa is supported by the backrest part 40Fb from a back side. An upper part of the backrest part 40Fb may be a headrest 40Fh supporting a head of the passenger from the back side.

The second seat 40R is located more backward than the first seat 40F away from the first seat 40F. The second seat 40R includes a seating part 40Ra and a backrest part 40Rb.

The vehicle body frame 20F may support a cover 23. The cover 23 may cover a front part of the floor frame 22 from a front side, an upper side, and right and left sides, for example. The cover 23 may cover a back part of the floor frame 22 from an upper side and right and left sides, for example.

A side cover 24 covering right and left outer sides of the passenger space may be supported on the vehicle body frame 20F. The side cover 24 may be a door openably and closably covering a left side or a right side of the passenger space.

The ROPS 30 is located above upper end parts of the seats 40F and 40R. The ROPS 30 is located above heads of the passengers seated on the seats 40F and 40R. A roof may be supported on the ROPS 30.

The ROPS 30 includes front-back frames 31R and 31L and laterals frames 32a and 32b, for example.

The front-back frames 31R and 31L are frames extending in a front-back direction on an upper side of the passenger space. For example, a front end of each of the front-back frames 31R and 31L is connected to a front part of the floor frame 22 in a position more frontward than the passenger space. For example, a back end of each of the front-back frames 31R and 31L is connected to a back part of the floor frame 22 in a position more backward than the passenger space. An intermediate portion of the front-back frames 31R and 31L in the front-back direction is curved to have a convex shape, and can pass through above the passenger space.

The front-back frames 31R and 31L are located away from each other in a right-left direction. For example, the front-back frame 31R is located closer to the right side in relation to the headrest 40Fh of the first seat 40F on the right side, and the front-back frame 31L is located closer to the left side in relation to the headrest 40Fh of the first seat 40F on the left side.

It is also applicable that the pillar frame 28 stands upward from an intermediate portion of right and left portions of the floor frame 22 in the longitudinal direction, and an upper end of the pillar frame 28 is connected to the intermediate portion of the front-back frames 31R and 31L in the longitudinal direction.

The lateral frame 32a extends along the vehicle width direction to connect the front-back frames 31R and 31L. The lateral frame 32a is an example of an attachment target portion to which the vehicle bracket 60 is attached in the vehicle body 20. The vehicle bracket 60 is attached to the lateral frame 32a at the intermediate portion of the vehicle body 20 in the vehicle width direction.

The lateral frame 32a may have a rod-like member. The lateral frame 32a is a rod-like member having a circular shape in cross section. The rod-like member having the circular shape in cross section indicates that an outer shape of the rod-like member in cross section perpendicular to the longitudinal direction is a circular shape. The case where the cross section has the circular shape includes not only a case where a cross section has a circular shape but also a case where a cross section has a shape that a circle is flatly compressed such as an oval shape, for example. In the present embodiment, the lateral frame 32a is a circular pipe-like member.

The lateral frame 32a may be located more frontward than the backrest part 40Fb of the first seat 40F. A state where the lateral frame 32a is located more frontward than the backrest part 40Fb indicates that the lateral frame 32a is located more frontward than a front end of the backrest part 40Fb. When the backrest part 40Fb extends from a back end of the seating part 40Fa in an obliquely backward and upward posture, a portion located foremost in a back end portion of the backrest part 40Fb is a front end of the backrest part 40Fb.

Since the lateral frame 32a is located more frontward than the backrest part 40Fb, the lateral frame 32a is easily located more frontward than a head portion of the passenger seated on the first seat 40F and leaning back into the backrest part 40Fb.

The lateral frame 32a may extend along the vehicle width direction. Since the lateral frame 32a extends along the vehicle width direction, the vehicle bracket 60 is easily attached to the lateral frame 32a at a position between the right and left first seats 40F in the vehicle width direction.

The lateral frame 32a may be located above the backrest part 40Fb. A state where the lateral frame 32a is located above the backrest part 40Fb indicates that the lateral frame 32a is located in a higher position than the upper end of the backrest part 40Fb.

The lateral frame 32a is located above the backrest part 40Fb, thus hardly blocks a front visual field of the passenger. The vehicle bracket 60 can be disposed in a position visually recognized by the passenger easily in a case where the passenger slightly displaces a visual line from a state of facing the front side.

The lateral frame 32b is located more backward than the lateral frame 32a. The lateral frame 32a and the lateral frame 32b are away from each other in the front-back direction. The lateral frame 32b may be located in a position overlapped with the headrest 40Fh of the first seat 40F or between the first seat 40F and the second seat 40R in the front-back direction.

The ROPS 30 may include an additional front-back frame 33a. For example, the additional front-back frame 33a may extend backward from the intermediate portion of the lateral frame 32a in the longitudinal direction. The additional front-back frame 33a may be connected to the lateral frame 32b. The additional front-back frame 33a may further extend backward from the lateral frame 32b. The number of the additional front-back frames 33a may be one, or the plurality of additional front-back frames 33a are also applicable. Exemplified in the present embodiment are two additional front-back frames 33a parallelly disposed at an interval in the vehicle width direction between the front-back frames 31R and 31L.

A connection structure of each of the frames 31R, 31L, 32a, 32b, and 33a described above is not particularly limited. For example, it is applicable that the frames are welded, connected by screwing, fixed by screwing via a bracket.

A material forming each of the frames 31R, 31L, 32a, 32b, and 33a described above is not particularly limited. Each of the frames 31R, 31L, 32a, 32b, and 33a may be made of metal.

The ROPS 30 may further include another frame in the vehicle width direction, the front-back direction, or an oblique direction.

The vehicle bracket 60 is attached to the lateral frame 32a described above. A support target component 100 is attached to the vehicle bracket 60 attached to the lateral frame 32a.

The support target component 100 is not particularly limited. The support target component 100 may be a component used by a passenger of the first seat 40F. The support target component 100 may be a component used by a driver during driving by the driver. The support target component 100 may be a component assisting driving by the driver.

The support target component 100 may be a rear view mirror, an accessory component, a display, a smartphone, a tablet terminal, a speaker, or a light, for example. Described in the present embodiment is an example that the support target component 100 is the rear view mirror.

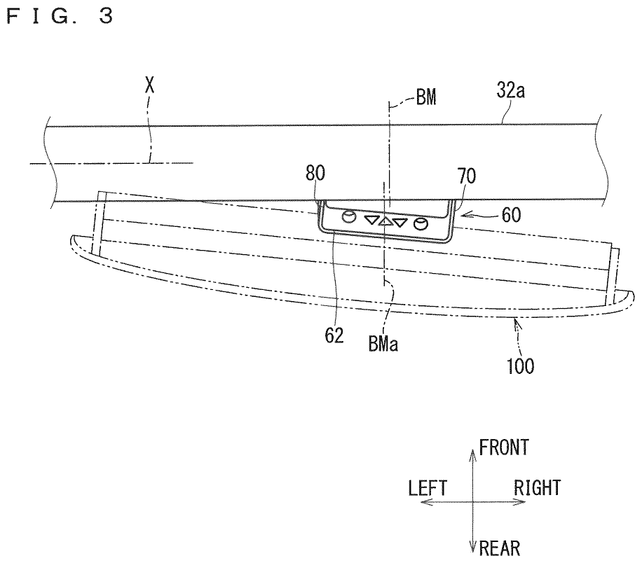

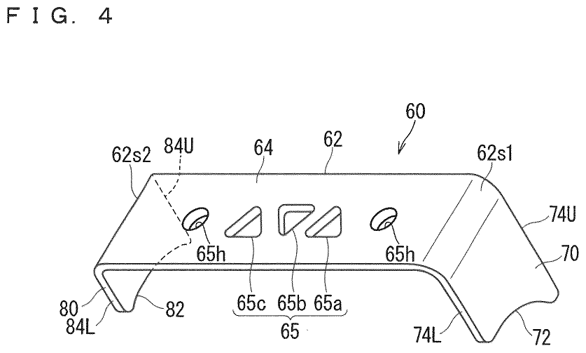

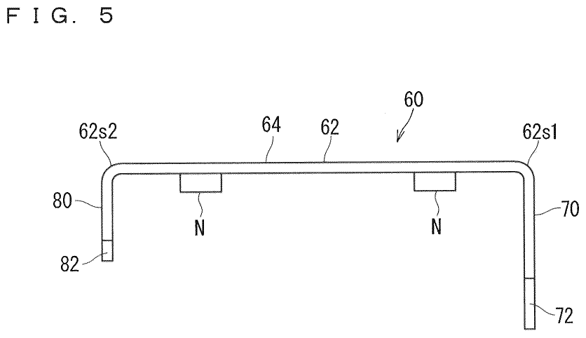

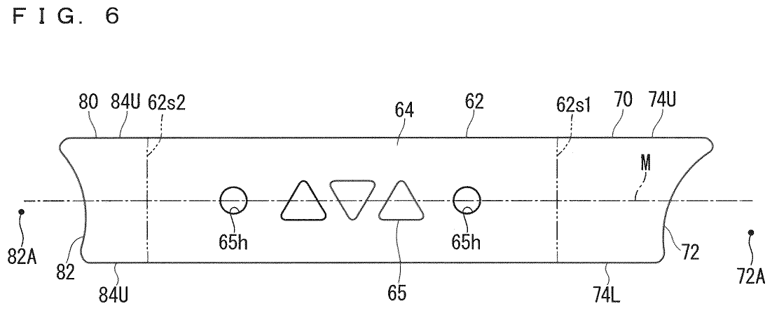

The vehicle bracket 60 is described more specifically. FIG. 3 is a plan view illustrating the bracket 60 attached to the lateral frame 32a. FIG. 4 is a perspective view illustrating the vehicle bracket 60. FIG. 5 is a bottom view illustrating the bracket 60. FIG. 6 is a development view illustrating the bracket 60.

The bracket 60 includes a base 62, a first leg portion 70, and a second leg portion 80.

The base 62 is a portion to which the support target component 100 is attached. The base 62 is formed into a rectangular plate-like shape. In the present embodiment, the base 62 has a rectangular plate-like shape having a first short side 62s1 and a second short side 62s2. The base 62 may be formed into the other shape such as a square shape or the other polygonal shape, for example.

The base 62 includes an attachment surface 64 to which the support target component 100 is attached. In the present embodiment, one main surface of the plate-like base 62 is the attachment surface 64. The base 62 includes a screw hole 65h as a configuration for attaching the support target component 100. For example, a hole is formed in the plate-like portion forming the base 62, and a nut N is attached to a portion of the plate-like portion on a side opposite to the attachment surface. The nut N is attached to the plate-like portion by welding or a fitting structure. The screw hole 65h of the nut N is continuous with a hole formed in the plate-like portion described above.

Since the screw S is inserted into the attachment hole formed in the support target component 100 and screwed to the screw hole 65h of the nut N, the support target component 100 is attached to the base 62.

In the present embodiment, the hole and the nut described above are located in two positions away from each other in the longitudinal direction of the base 62. Thus, the support target component 100 can be fixed to the base 62 by screwing at two positions. The number of holes and positions for screwing included in the base 62 is optionally set.

The base 62 may include an identification mark 65. The identification mark 65 is a mark for enabling identification of a direction of the base 62. For example, when the bracket 60 is seen from a side of the attachment surface 64 in attaching the bracket 60 to the lateral frame 32a, there is a possibility of wondering which of two long sides facing each other in the base 62 should be located an upper side or a lower side. Thus, the identification mark 65 may be a mark for enabling identification of a direction of the base 62 in a width direction. The identification mark 65 may be a mark enabling identification of a direction intersecting with both a line connecting the first leg portion 70 and the second leg portion 80 and protrusion direction of the first leg portion 70.

The identification mark 65 may be a triangle mark, for example. In the example illustrated in FIG. 6, the identification mark 65 includes three triangle hole-shaped triangle marks 65a, 65b, and 65c arranged along the longitudinal direction of the base 62. One of three sides of the middle triangle mark 65b is located closer to one side of the base 62 as a bottom side, and a vertex facing the bottom side is located closer to the other side of the base 62. One of three sides of each of two triangle marks 65a and 65c on both ends is located closer to the other side of the base 62 as a bottom side in the longitudinal direction of the base 62, and a vertex facing the bottom side is located closer to one side of the base 62. The bracket 60 is attached to the lateral frame 32a while one side is disposed above the other side. Thus, a posture in which directions of vertexes of two triangle marks 65a and 65c on both ends indicates a direction of attaching the base 62.

The identification mark 65 is not limited to the shape described above; however, any mark is applicable as long as it has directionality. It is applicable that the identification mark is not a hole but is a depression or a convex portion, or a mark formed by printing is also applicable.

The first leg portion 70 is a portion protruding from the base 62 and fixed to the lateral frame 32a. The second leg portion 80 protrudes from the base 62 at a position away from the first leg portion 70. The second leg portion 80 is fixed to the lateral frame 32a. The first leg portion 70 and the second leg portion 80 protrude to a side opposite to the attachment surface 64 in relation to the base 62.

The first leg portion 70 may have a plate-like shape extending from the first short side 62s1 in a direction intersecting with the base 62. The second leg portion 80 may have a plate-like shape extending from the second short side 62s2 in a direction intersecting with the base 62.

When the base 62 has a plate-like shape having the first short side 62s1 and the second short side 62s2 and each of the leg portions 70 and 80 has a plate-like extending from the short sides 62s1 and 62s2 in the direction intersecting with the base 62, the bracket 60 can be easily formed by punching and bending a metal plate, for example. For example, as illustrated in FIG. 6, the metal plate is punched into a shape that the first leg portion 70 is continuously formed with one end of the base 62 and the second leg portion 80 is continuously formed with the other end of the base 62. For example, the first leg portion 70, the base 62, and the second leg portion 80 are continuously formed straight in this order.

A protrusion direction of the first leg portion 70 and the second leg portion 80 protruding from the base 62 is optionally set. In the present embodiment, the first leg portion 70 and the second leg portion 80 protrude in the same direction along a direction intersecting with the longitudinal direction of the base 62. Herein, the first leg portion 70 and the second leg portion 80 protrude in the same direction along a direction perpendicular with the longitudinal direction of the base 62. Thus, the first leg portion 70 and the second leg portion 80 extend in parallel to each other.

It is also applicable that the first leg portion 70 and the second leg portion 80 are not perpendicular with the longitudinal direction of the base 62 but are inclined with respect thereto. For example, the first leg portion 70 and the second leg portion 80 may extend to be inclined with respect to the base 62 so as to be sequentially opened as getting away from the base 62. For example, the first leg portion 70 and the second leg portion 80 may be inclined in the same side with respect to the base 62 and extend in parallel to each other.

The first leg portion 70 has a configuration that a fixing edge 72 is formed on a distal end of a quadrangular shape on a side opposite to the base 62. A width of the first leg portion 70 may be the same as the width of the base 62.

The fixing edge 72 is formed into a shape corresponding to an outer shape of the attachment target portion. Herein, the fixing edge 72 is formed into an arc-like shape conforming to an outer shape of the lateral frame 32a. A curvature radius of the fixing edge 72 may be the same as that of the lateral frame 32a. The fixing edge 72 is disposed along an outer peripheral surface of the lateral frame 32a as a first arc-like edge.

The fixing edge 72 is formed into a shape concaved to a side of the base 62 with a larger degree at the other side than one side of the base 62. For example, when seen along the longitudinal direction of the lateral frame 32a, a first curvature center 72A of the fixing edge 72 is located closer to the other side of the base 62 to be deviated in relation to center line M in the width direction of the base 62.

Since the fixing edge 72 has an asymmetry shape in a width direction of the first leg portion 70, a length is different between an upper portion 74U and a lower portion 74L of the first leg portion 70. In the present embodiment, the upper portion 74U is longer than the lower portion 74L.

The second leg portion 80 has a configuration that a fixing edge 82 is formed on an end part of a quadrangular shape on a side opposite to the base 62. A width of the second leg portion 80 may be the same as the width of the base 62.

The fixing edge 82 is formed into a shape corresponding to an outer shape of the attachment target portion. Herein, the fixing edge 82 is formed into an arc-like shape conforming to an outer shape of the lateral frame 32a. A curvature radius of the fixing edge 82 may be the same as that of the lateral frame 32a. The fixing edge 82 is disposed along the outer peripheral surface of the lateral frame 32a as a second arc-like edge.

The fixing edge 82 is formed into a shape concaved to a side of the base 62 with a larger degree at the other side than one side of the base 62 in the manner similar to the fixing edge 72. For example, when seen along the longitudinal direction of the lateral frame 32a, a curvature center 82A of the fixing edge 82 may be located closer to the other side of the base 62 to be deviated in relation to center line M in the width direction of the base 62 in the manner similar to the curvature center 72A of the fixing edge 72.

Since the fixing edge 82 has an asymmetry shape in a width direction of the second leg portion 80, a length is different between an upper portion 84U and a lower portion 84L of the second leg portion 80. In the present embodiment, the upper portion 84U is longer than the lower portion 84L.

A length is different between the fixing edge 72 as the first arc-like edge and the fixing edge 82 as the second arc-like edge. In the present embodiment, the fixing edge 72 is longer than the fixing edge 82. As described above, the curvature center 72A of the fixing edge 72 and the curvature center 82A of the fixing edge 82 are located closer to the other side of the base 62 to be deviated in relation to center line M in the width direction of the base 62. The curvature center 72A is farther away from the center line M than the curvature center 82A is. When a circle is cut by a rectangle passing across the circle, the fixing edges 72 and 82 draw a shape corresponding to an arc-like shape located in the rectangle in an outer periphery of the circle. As the rectangle passes across a position deviated from a center of the circle with a larger degree, the length of the arc-like shape increases. Thus, when the curvature center 72A is farther away from the center line M in relation to the curvature center 82A, the length of the fixing edge 72 is larger than that of the fixing edge 82.

The difference of the length between the fixing edges 72 and 82 described above can be influenced by the difference of the length between the leg portions 70 and 80.

The first leg portion 70 and the second leg portion 80 are bent with respect to both ends of the base 62 described above. In the present embodiment, the first leg portion 70 and the second leg portion 80 are bent to be perpendicular to the base 62.

The first leg portion 70 is longer than the second leg portion 80. For example, a length of the first leg portion 70 from a base end continuously formed with the base 62 to a distal end of the first leg portion 70 is larger than that of the second leg portion 80 from a base end continuously formed with the base 62 to a distal end of the second leg portion 80. For example, a shortest distance from the base end of the first leg portion 70 continuously formed with the base 62 to a portion thereof fixed to the lateral frame 32a is larger than that from the base end of the second leg portion 80 continuously formed with the base 62 to a portion thereof fixed to the lateral frame 32a. For example, a length at the center line M in the width direction of the first leg portion 70 is larger than that at the center line M in the width direction of the second leg portion 80.

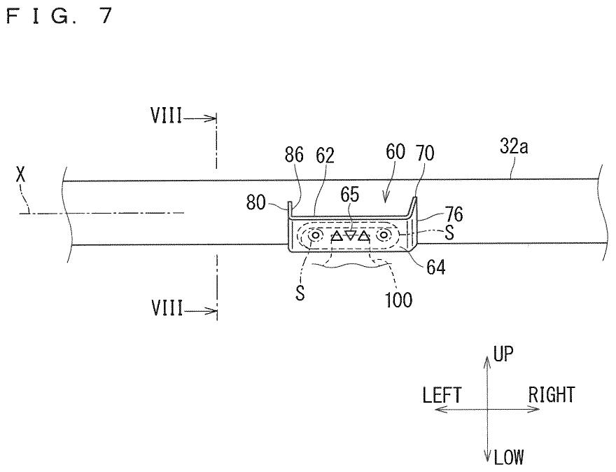

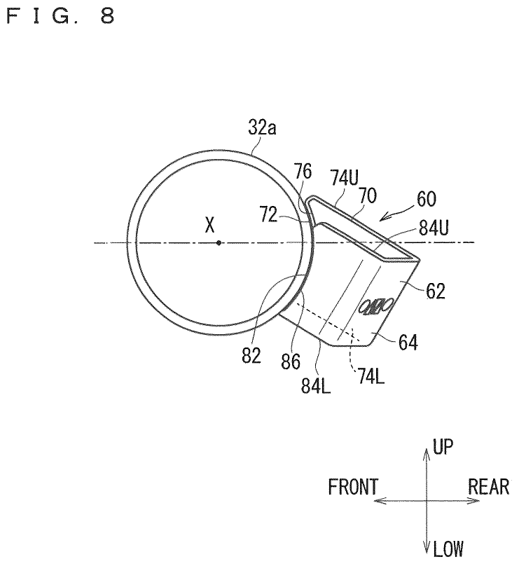

A fixing structure of the bracket 60 fixed to the lateral frame 32a is described more specifically. FIG. 7 is a back view illustrating the bracket 60 attached to the lateral frame 32a. FIG. 7 illustrates the support target component 100 partially by a dash-double-dot line. FIG. 8 is a cross-sectional view at a VIII-VIII line in FIG. 7.

As illustrated in FIG. 1 to FIG. 3, FIG. 7, and FIG. 8, the bracket 60 is attached to the lateral frame 32a. The lateral frame 32a extends along the vehicle width direction. The bracket 60 includes the first leg portion 70 and the second leg portion 80. The first leg portion 70 and the second leg portion 80 are fixed to the lateral frame 32a at positions away from each other in the longitudinal direction of the lateral frame 32a.

For example, each of the fixing edge 72 of the first leg portion 70 and the fixing edge 82 of the second leg portion 80 may be welded and fixed to the outer peripheral surface of the lateral frame 32a while having contact with the outer peripheral surface thereof.

The first leg portion 70 may be fixed to the lateral frame 32a at a position farther away from the steering wheel 17 than the second leg portion 80 is. In the present embodiment, the steering wheel 17 is located on a left side in the vehicle body 20. Thus, the first leg portion 70 is located closer to a right side in relation to the second leg portion 80.

The first leg portion 70 is longer than the second leg portion 80. Thus, the first short side 62s1 located farther away from the steering wheel 17 in the base 62 is disposed in a position farther away from the lateral frame 32a than the second short side 62s2 is. Thus, the base 62 has an inclined posture that the first short side 62s1 is disposed farther away from the lateral frame 32a in relation to the second short side 62s2. Since the base 62 is inclined with respect to the lateral frame 32a, the attachment surface 64 is inclined with respect to the vehicle width direction. The support target component 100 supported on the base 62 is also inclined with respect to the lateral frame 32a easily.

In this case, the attachment surface 64 may be inclined immediately backward to face one of the right and left first seats 40F when seen from above. The attachment surface 64 may be inclined immediately backward to face the headrest 40Fh of one of the right and left first seats 40F when seen from above.

The attachment surface 64 may be inclined to one side in the front-back direction as proceeding from one side to the other side in the vehicle width direction. The attachment surface 64 may be inclined to one side in the up-down direction as proceeding from one side to the other side in the vehicle width direction. The attachment surface 64 may be inclined in both one direction along the front-back direction and one direction along the up-down direction as proceeding from one side to the other side in the vehicle width direction.

For example, the attachment surface 64 may be inclined with respect to a line in the front-back direction to have an acute angle with respect to the line in the front-back direction on a side of the steering wheel 17 when seen from above. For example, the attachment surface 64 may be inclined with respect to a line in the front-back direction to have an acute angle with respect to the line in the front-back direction on the lower side when seen from one side in the vehicle width direction.

The bracket 60 is supported on an intermediate position of the lateral frame 32a in the vehicle width direction. The bracket 60 is located between the right and left first seats 40F, for example. The base 62 may pass across a line BM in a center of the vehicle body 20 in the width direction. In this case, the support target component 100 can be disposed between two passengers seated on the right and left first seats 40F, respectively. When the support target component 100 is a rear view mirror, a driver seated on the first seat 40F on the side of the steering wheel 17 can visually recognize the back side easily using a space between the right and left first seats 40F via a rear view mirror. When the support target component 100 is a component usable by two passengers seated on the right and left first seats 40F, the passengers can have easily access to the support target component 100.

For example, a fixing position of the first leg portion 70 fixed to the lateral frame 32a is a first fixing portion 76, and a fixing position of the second leg portion 80 fixed to the lateral frame 32a is a second fixing portion 86. The first fixing portion 76 is located away to the right side in relation to the line BM in the center in the vehicle width direction, and the second fixing portion 86 is located away to the left side in relation to the line BM in the center in the vehicle width direction. Thus, the line BM in the center in the vehicle width direction passes across the base 62 between the first leg portion 70 and the second leg portion 80.

When a distance of the first fixing portion 76 from the line BM in the center in the vehicle width direction is the same as a distance of the second fixing portion 86 from the line BM, the base 62 is inclined with respect to the lateral frame 32a and is deviated to the side of the shorter second leg portion 80 by reason that the first leg portion 70 is longer than the second leg portion 80. Thus, a position BMa in the center of the base 62 in the vehicle width direction is deviated to the side of the steering wheel 17 in relation to the line BM in the center of the vehicle body 20 in the vehicle width direction. Since the position BMa in the center of the base 62 in the vehicle width direction is deviated to the side of the steering wheel 17, a driver can easily use the support target component 100 supported on the bracket 60.

The lateral frame 32a may be located above the backrest part 40Fb and more frontward than the backrest part 40Fb of the first seat 40F. The base 62 may face an obliquely downward and backward so that a passenger on the first seat 40F can easily use the support target component 100 supported on the lateral frame 32a via the bracket 60. For example, when the attachment surface 64 of the base 62 faces a face or the headrest 40Fh of a passenger on the first seat 40F along the vehicle width direction, the passenger on the first seat 40F can visually recognize and easily use the support target component 100.

The base 62 may be located below a center axis X of the lateral frame 32a. The base 62 is located below the center axis X, thus can be easily supported at a position close to the face or the headrest 40Fh of the passenger on the first seat 40F in a posture of facing obliquely downward and backward.

A height may be different between the first fixing portion 76 and the second fixing portion 86. Since the height is different between the first fixing portion 76 and the second fixing portion 86, the posture of the base 62 with respect to the lateral frame 32a can be easily adjusted.

For example, the first leg portion 70 and the second leg portion 80 are assumed to be fixed to the lateral frame 32a at the same height. In this case, since the first leg portion 70 is longer than the second leg portion 80, a portion of the base 62 on the side of the first leg portion 70 is disposed in a position lower than a portion thereof on the side of the second leg portion 80. Thus, the base 62 is inclined downward to the right side with respect to the lateral frame 32a when seen from the back side.

In the present embodiment, one side located above the base 62 is located in the same height when seen from the back side. That is to say, the base 62 has a horizontal posture along the vehicle width direction when seen from the back side. Since the first leg portion 70 is longer than the second leg portion 80, it is sufficient that the first fixing portion 76 of the first leg portion 70 is located farther away from the base 62 than the fixing portion 86 of the second leg portion 80 is to make the base 62 have the horizontal posture. Thus, the first fixing portion 76 is located in a higher position than the second fixing portion 86. Thus, the difference in length between the leg portion s 70 and 80 can be absorbed by the heights of the fixing portion s 76 and 86 while the base 62 has the horizontal posture.

For example, when a rear view mirror is attached as the support target component 100 to the bracket 60, a mirror surface of the rear view mirror can easily have a posture inclined with respect to the lateral frame 32a in the manner similar to the attachment surface 64. For example, the mirror surface can easily have a posture inclined obliquely downward to a side of the driver seat.

The rear view mirror may have a configuration enabling adjustment of the posture with respect to the bracket 60 or a fixing support structure that the posture cannot be adjusted with respect to the bracket 60. When the rear view mirror has the fixing support structure, the posture of the mirror surface with respect to the lateral frame 32a is hardly changed even when the vehicle 10 vibrates.

According to the vehicle bracket 60 and the vehicle 10 having the above configurations, the first leg portion 70 of the bracket 60 is longer than the second leg portion 80. Thus, when the first leg portion 70 and the second leg portion 80 are fixed to the lateral frame 32a at the positions away from each other in the vehicle width direction, the base 62 is supported in the oblique posture with respect to the vehicle width direction. Accordingly, the support target component 100 is easily supported in the posture inclined with respect to the vehicle width direction.

The first leg portion 70 located away from the steering wheel 17 is longer than the second leg portion 80. Thus, a portion of the base 62 on a side away from the steering wheel 17 is away from the lateral frame 32a with a large degree, and is easily supported in a state of being inclined to the side of the steering wheel 17. The support target component 100 supported on the base 62 is also easily supported in the state of being inclined to the side of the steering wheel 17.

The base 62 passes across the line BM in the center of the vehicle body 20 in the vehicle width direction. Thus, the support target component 100 is attached near the center of the vehicle body 20 in the vehicle width direction. When the support target component 100 is the rear view mirror, the driver can visually recognize the back side easily using the space in the center in the vehicle width direction. The passengers on the right and left first seats 40F can easily use the support target component 100.

The base 62 faces obliquely downward and backward. Thus, the support target component 100 attached to the base 62 easily faces obliquely downward and backward. Accordingly, the passenger on the first seat 40F can easily use the support target component 100.

The base 62 is located below the center axis X of the lateral frame 32a. Thus, the support target component 100 supported on the base 62 is easily supported at the position closer to the lower side in relation to the lateral frame 32a. The passengers on the right and left first seats 40F can easily use the support target component 100.

Thus, the line BMa in the center of the base 62 in the vehicle width direction is deviated to the side of the steering wheel 17 in relation to the line BM in the center of the vehicle body 20 in the vehicle width direction. Thus, the support target component 100 supported on the bracket 60 is deviated to the side of the first seat 40F on which the driver is seated. Accordingly, the support target component 100 is easily disposed in the position at which the driver can easily use the support target component 100.

The height is different between the first fixing portion 76 and the second fixing portion 86. The posture of the base 62 is easily adjusted compared with a case where the first fixing portion 76 and the second fixing portion 86 are located in the same height position with respect to the lateral frame 32a.

For example, when the first fixing portion 76 is higher than the second fixing portion 86, the first fixing portion 76 of the relatively long first leg portion 70 is located farther away from the steering wheel 17 in relation to the second fixing portion 86 of the relatively short second leg portion 80; thus, the base 62 is easily supported in the state of being inclined to the side of the steering wheel 17. Since the first fixing portion 76 is higher than the second fixing portion 86, the posture of the base 62 is easily supported to be close to the horizontal posture.

When seen along the longitudinal direction of the rod-like lateral frame 32a, the first curvature center 72A of the fixing edge 72 is located to be deviated in relation to center line M in the width direction of the first leg portion 70, and the second curvature center 82A of the fixing edge 82 is located to be deviated in relation to center line M in the width direction of the second leg portion 80. Thus, the base 62 is supported to be inclined with a larger degree compared with a case where the curvature center of the arc-like edge is located on extension of the center line of each leg portion in the width direction.

When the length is different between the fixing edge 72 and the fixing edge 82, the whole fixing edge 72 and the whole fixing edge 82 can be easily disposed along the circumferential direction of the lateral frame 32a even when the position is different between the fixing edge 72 and the fixing edge 82 in the circumferential direction of the lateral frame 32a. Accordingly, the whole fixing edge 72 and the whole fixing edge 82 can be easily attached to the different positions in the lateral frame 32a in the circumferential direction.

When the first leg portion 70 and the second leg portion 80 protrude from the base 62 in the parallel posture, the upper portion 74U of the first leg portion 70 is longer than the lower portion 74L, and the upper portion 84U of the second leg portion 80 is longer than the lower portion 84L, the base 62 is easily supported in the obliquely downward posture and the oblique posture with respect to the lateral frame 32a.

The bracket 60 can be easily formed by processing the plate material when the base 62 has the rectangular plate-like shape with the first short side 62s1 and the second short side 62s2, the first leg portion 70 has the plate-like shape extending from the first short side 62s1 in the direction intersecting with the base 62, and the second leg portion 80 has the plate-like shape extending from the second short side 62s2 in the direction intersecting with the base 62.

Since the base 62 includes the identification mark 65, the bracket 60 can be fixed to the lateral frame 32a while the direction of the base 62 is confirmed based on the identification mark 65 as a clue. Accordingly, an error in a direction of attaching the bracket 60 is suppressed.

The lateral frame 32a is located above the backrest part 40Fb of the first seat 40F. The bracket 60 having the leg portions 70 and 80 with the different lengths is supported on this lateral frame 32a. Accordingly, the attachment surface 64 of the bracket 60 easily faces obliquely downward.

Since the support target component 100 is attached to the base 62, the support target component 100 easily faces the passenger on the first seat 40F. Since the base 62 is located below the center axis X of the lateral frame 32a, the support target component 100 is easily disposed near the face of the passenger on the first seat 40F.

Since the first leg portion 70 and the second leg portion 80 are fixed to the lateral frame 32a by welding, the bracket 60 is firmly fixed to the lateral frame 32a easily.

The leg portions 70 and 80 are fixed to the lateral frame in the state where the attachment surface 64 is inclined with respect to the vehicle width direction, the support target component 100 is easily supported in the posture inclined with respect to the vehicle width direction.

Described in the above embodiment is the example that the leg portions 70 and 80 are welded to the lateral frame 32a. The attachment structure of attaching the first leg portion and the second leg portion to the attachment targe portion is not limited to the above example. For example, one of or both the first leg portion and the second leg portion may be fixed to the attachment target portion by screwing, swaging, or fitting.

Described in the above embodiment is the example that the base 62 and the leg portions 70 and 80 are formed by performing press work on one metal plate. The bracket may be formed by casting, cutting work, or molding. The bracket may be manufactured by combining components.

Described in the above embodiment is the example that the support target component 100 is screwed to the bracket 60. The attachment structure of attaching the support target component to the bracket is not limited to the above example. For example, the bracket or the support target component may include a clamp structure of clamping a component using spring properties or screw fastening. The bracket or the support target component may include a portion with a concave portion to which a part of a counterpart component is fitted and fixed using elasticity, for example. The attachment structure of attaching the support target component to the bracket 60 may be a structure of attaching and detaching the support target component without breaking the component and the bracket.

### Appendix

The present disclosure discloses each aspect described hereinafter.

A first aspect is a vehicle bracket attached to an attachment target portion of a vehicle body in an intermediate portion of the vehicle body in a vehicle width direction, including: a base to which a support target component is attached; a first leg portion protruding from the base and fixed to the attachment target portion; and a second leg portion protruding from the base at a position away from the first leg portion and fixed to the attachment target portion, wherein the first leg portion is longer than the second leg portion.

According to the vehicle bracket, the first leg portion is longer than the second leg portion. Thus, when the first leg portion and the second leg portion are fixed to the attachment target portion at the positions away from each other in the vehicle width direction, the base is supported in the oblique posture with respect to the vehicle width direction. Accordingly, the support target component is easily supported in the posture inclined with respect to the vehicle width direction.

A second aspect is the vehicle bracket according to the first aspect, wherein the first leg portion may be fixed to the attachment target portion at a position farther away from a steering wheel in relation to the second leg portion.

In this case, since the first leg in a position away from the steering wheel is longer than the second leg portion, the base is easily supported in the state of being inclined to the side of the steering wheel. The support target component supported on the base is also easily supported in the state of being inclined to the side of the steering wheel.

A third aspect is the vehicle bracket according to the first or second aspect, wherein the base may pass across a center of the vehicle body in a width direction.

Accordingly, the support target component is attached near the center of the vehicle body in the width direction.

A fourth aspect is the vehicle bracket according to any one of the first to third aspects, wherein the base may face obliquely downward and backward.

In this manner, when the base faces obliquely downward and backward, the support target component attached to the base easily faces obliquely downward and backward.

A fifth aspect is the vehicle bracket according to any one of the first to fourth aspects, wherein it is applicable that the attachment target portion is a rod-like member extending along the vehicle width direction, and the base is located below a center axis of the rod-like member.

Accordingly, the support target component supported on the base is easily supported at the position closer to the lower side in relation to the rod-like member.

A sixth aspect is the vehicle bracket according to any one of the first to fifth aspects, wherein a center of the base in a vehicle width direction may be located to be deviated to a side of a steering wheel in relation to the center of the vehicle body in the width direction.

In this case, the support target component supported on the vehicle bracket is easily disposed in a position at which the driver can easily use the support target component.

A seventh aspect is the vehicle bracket according to any one of the first to sixth aspects, wherein it is applicable that the attachment target portion is a rod-like member, and a height is different between a first fixing portion in which the first leg portion is fixed to the rod-like member and a second fixing portion in which the second leg portion is fixed to the rod-like member.

In this case, since the height is different between the first fixing portion and the second fixing portion, the posture of the base is easily adjusted.

An eighth aspect is the vehicle bracket according to the seventh aspect, wherein it is applicable that the first fixing portion is located farther away from a steering wheel in relation to the second fixing portion, and the first fixing portion is higher than the second fixing portion in height.

In this case, since the first fixing portion of the relatively long first leg portion is located farther away from the steering wheel in relation to the second fixing portion of the relatively short second leg portion; thus, the base is easily supported in the state of being inclined to the side of the steering wheel. Since the first fixing portion is higher than the second fixing portion, the posture of the base is easily supported to be close to the horizontal posture.

A ninth aspect is the vehicle bracket according to any one of the first to eighth aspects, wherein it is applicable that the attachment target portion is a rod-like member having a circular shape in cross section, the first leg portion includes a first arc-like edge disposed along an outer peripheral surface of the rod-like member on a distal end of the first leg portion, the second leg portion includes a second arc-like edge disposed along the outer peripheral surface of the rod-like member on a distal end of the second leg portion, and when seen along a longitudinal direction of the rod-like member, a first curvature center of the first arc-like edge is located to be deviated in relation to a center line of the first leg portion in a width direction, and a second curvature center of the second arc-like edge is located to be deviated in relation to a center line of the second leg portion in a width direction.

In this case, the base is supported to be inclined with a larger degree.

A tenth aspect is the vehicle bracket according to the ninth aspect, wherein a length may be different between the first arc-like edge and the second arc-like edge.

In this case, the first arc-like edge and the second arc-like edge are easily attached to the different positions in the circumferential direction in the rod-like member having the circular shape in cross section.

An eleventh aspect is the vehicle bracket according to any one of the first to tenth aspects, wherein it is applicable that the first leg portion and the second leg portion extend in parallel to each other, an upper portion of the first leg portion is longer than a lower portion of the first leg portion, and an upper portion of the second leg portion is longer than a lower portion of the second leg portion.

Accordingly, the base is easily supported in the obliquely downward posture and the oblique posture with respect to the attachment target portion.

A twelfth aspect is the vehicle bracket according to any one of the first to eleventh aspects, wherein it is applicable that the base has a rectangular plate-like shape with a first short side and a second short side, the first leg portion has a plate-like shape extending from the first short side in a direction intersecting with the base, and the second leg portion has a plate-like shape extending from the second short side in a direction intersecting with the base.

In this case, the vehicle bracket can be easily formed by processing the plate material.

A thirteenth aspect is the vehicle bracket according to any one of the first to twelfth aspects, wherein the base may include an identification mark enabling identification of a direction.

Accordingly, the vehicle bracket can be fixed to the attachment target portion while the direction of the base is confirmed.

A vehicle according to a fourteenth aspect is a vehicle including: a vehicle body including a vehicle body frame including a rollover protective structure (ROPS); a seat including a seating part and a backrest part; and a vehicle bracket, wherein the rollover protective structure has a rod-like member located more frontward than the backrest part and extending along a vehicle width direction, the vehicle bracket includes: a base to which a support target component is attached; a first leg portion protruding from the base and fixed to the rod-like member; and a second leg portion protruding from the base at a position away from the first leg portion and fixed to the rod-like member, and the first leg portion is longer than the second leg portion.

According to the vehicle, the first leg portion of the vehicle bracket is longer than the second leg portion. Thus, when the first leg portion and the second leg portion are fixed to the attachment target portion at the positions away from each other in the vehicle width direction, the base is supported in the oblique posture with respect to the vehicle width direction. Accordingly, the support target component is easily supported in the posture inclined with respect to the front-back direction.

A fifteenth aspect is the vehicle according to the fourteenth aspect, wherein the rod-like member may be located above the backrest part.

Accordingly, the vehicle bracket is supported on the rod-like member located above the backrest part.

A sixteenth aspect is the vehicle according to the fifteenth aspects, wherein the base may face obliquely downward and backward.

In this case, since the base faces obliquely downward and backward, the support target component attached to the base easily faces the face of the passenger.

A seventeenth aspect is the vehicle according to any one of the fourteenth to sixteenth aspects, wherein the first leg portion and the second leg portion may be fixed to the rod-like member by welding.

Accordingly, the vehicle bracket is firmly attached to the attachment target portion by welding easily.

A eighteenth aspect is the vehicle according to any one of the fourteenth to seventeenth aspects, wherein the support target component is a rearview mirror.

A vehicle bracket according to the eighteenth aspect is a vehicle bracket attached to an attachment target portion of a vehicle body in an intermediate portion of the vehicle body in a vehicle width direction, including: a base including an attachment surface to which a support target component is attached; and a leg portion protruding from the base and fixed to the attachment target portion, wherein the leg portion is fixed to the attachment target portion in a state where the attachment surface is inclined with respect to a vehicle width direction.

According to the vehicle bracket, the attachment surface is supported in the posture inclined with respect to the vehicle width direction. Accordingly, the support target component is easily supported in the posture inclined with respect to the vehicle width direction.

The present disclosure also discloses a vehicle in which the vehicle bracket according to any one of the first to thirteenth and eighteenth aspects described above is fixed to a vehicle body.

Each configuration described in the above-mentioned embodiments and each modification example can be combined with each other as appropriate unless any contradiction occurs.

The foregoing description is in all aspects illustrative and does not restrict the present invention. Numerous modifications and variations that have not yet been exemplified are devised without departing from the scope of the present invention.

1. A vehicle bracket attached to an attachment target portion of a vehicle body in an intermediate portion of the vehicle body in a vehicle width direction, comprising:
a base to which a support target component is attached;
a first leg portion protruding from the base and fixed to the attachment target portion; and
a second leg portion protruding from the base at a position away from the first leg portion and fixed to the attachment target portion, wherein
the first leg portion is longer than the second leg portion.

2. The vehicle bracket according to claim 1, wherein
the first leg portion is fixed to the attachment target portion at a position farther away from a steering wheel in relation to the second leg portion.

3. The vehicle bracket according to claim 1, wherein
the base passes across a center of the vehicle body in a width direction.

4. The vehicle bracket according to claim 1, wherein
the base faces obliquely downward and backward.

5. The vehicle bracket according to claim 1, wherein
the attachment target portion is a rod-like member extending along the vehicle width direction, and
the base is located below a center axis of the rod-like member.

6. The vehicle bracket according to claim 1, wherein
a center of the base in a vehicle width direction is located to be deviated to a side of a steering wheel in relation to the center of the vehicle body in the width direction.

7. The vehicle bracket according to claim 1, wherein
the attachment target portion is a rod-like member, and
a height is different between a first fixing portion in which the first leg portion is fixed to the rod-like member and a second fixing portion in which the second leg portion is fixed to the rod-like member.

8. The vehicle bracket according to claim 7, wherein
the first fixing portion is located farther away from a steering wheel in relation to the second fixing portion, and
the first fixing portion is higher than the second fixing portion in height.

9. The vehicle bracket according to claim 1, wherein
the attachment target portion is a rod-like member having a circular shape in cross section,
the first leg portion includes a first arc-like edge disposed along an outer peripheral surface of the rod-like member on a distal end of the first leg portion,
the second leg portion includes a second arc-like edge disposed along the outer peripheral surface of the rod-like member on a distal end of the second leg portion, and
a first curvature center of the first arc-like edge is located to be deviated in relation to a center line of the first leg portion in a width direction, and a second curvature center of the second arc-like edge is located to be deviated in relation to a center line of the second leg portion in a width direction.

10. The vehicle bracket according to claim 9, wherein
a length is different between the first arc-like edge and the second arc-like edge.

11. The vehicle bracket according to claim 1, wherein
the first leg portion and the second leg portion extend in parallel to each other,
an upper portion of the first leg portion is longer than a lower portion of the first leg portion, and
an upper portion of the second leg portion is longer than a lower portion of the second leg portion.

12. The vehicle bracket according to claim 1, wherein
the base has a rectangular plate-like shape with a first short side and a second short side,
the first leg portion has a plate-like shape extending from the first short side in a direction intersecting with the base, and
the second leg portion has a plate-like shape extending from the second short side in a direction intersecting with the base.

13. The vehicle bracket according to claim 1, wherein
the base includes an identification mark enabling identification of a direction.

14. A vehicle, comprising:
a vehicle body including a vehicle body frame including a rollover protective structure;
a seat including a seating part and a backrest part; and
a vehicle bracket, wherein
the rollover protective structure has a rod-like member located more frontward than the backrest part and extending along a vehicle width direction,
the vehicle bracket includes:
a base to which a support target component is attached;
a first leg portion protruding from the base and fixed to the rod-like member; and
a second leg portion protruding from the base at a position away from the first leg portion and fixed to the rod-like member, and
the first leg portion is longer than the second leg portion.

15. The vehicle according to claim 14, wherein
the rod-like member is located above the backrest part.

16. The vehicle according to claim 15, wherein
the base faces obliquely downward and backward.

17. The vehicle according to claim 14, wherein
the first leg portion and the second leg portion are fixed to the rod-like member by welding.

18. The vehicle according to claim 14, wherein
the support target component is a rearview mirror.

19. A vehicle bracket attached to an attachment target portion of a vehicle body in an intermediate portion of the vehicle body in a vehicle width direction, comprising:
a base including an attachment surface to which a support target component is attached; and
a leg portion protruding from the base and fixed to the attachment target portion, wherein
the leg portion is fixed to the attachment target portion in a state where the attachment surface is inclined with respect to a vehicle width direction.
